(19) United States
(12) Patent Application Publication
(10) Pub. No.: US 2013/0226824 A1
(43) Pub. Date: Aug. 29, 2013

(54) Methods, Software and Devices for Managing Approval of a Proposed Contract With Multiple Decision Makers

(71) Applicants: Michael Wilson, Uxbridge (CA); Ching Chan, Markham (CA)

(72) Inventors: Michael Wilson, Uxbridge (CA); Ching Chan, Markham (CA)

(73) Assignee: First Capital Realty Inc., Toronto (CA)

(21) Appl. No.: 13/779,369

(22) Filed: Feb. 27, 2013

(30) Foreign Application Priority Data
Feb. 28, 2012 (CA) 2,769,793

(51) Int. Cl. G06Q 10/10

(52) U.S. Cl. CPC G06Q 10/10
USPC 705/342

(57) ABSTRACT

Methods, software, and devices for requesting approvals for a proposed contract from a plurality of hierarchical decision-makers are disclosed. A plurality of contract parameters of the proposed contract are received. Using the parameters, those decision-makers from whom approval of the proposed contract is required are automatically identified by comparing those parameters to stored approval criteria. An electronic representation of differences between the plurality of contract parameters and a prior-received contract parameters is generated. Identified decision-makers are arranged in a defined hierarchical order. The generated electronic representation of differences is electronically communication to the first identified decision-maker in the hierarchy, as ordered. Approval by the first identified decision-maker is received by electronic notification. Sending the generated electronic representation of differences and receiving approval are repeated for each subsequent decision-maker, as ordered. Ultimately, electronic notification of approval may be provided to at least one stakeholder.

### CROSS REFERENCE TO RELATED APPLICATIONS

This U.S. patent application claims priority under 35 U.S.C. §119(a-d) to Canadian Patent Application 2,769,793, filed Feb. 28, 2012, which is hereby incorporated by reference in its entirety.

### TECHNICAL FIELD

The present disclosure relates to managing contracts, and particularly to methods, software, and devices for requesting approval of a proposed contract from multiple decision-makers and notifying multiple stakeholders when the proposed contract is approved or rejected.

### BACKGROUND

A contract is formed when an offer is made by one party and accepted by another. In contracts where one or both of the parties is an organization, the authority to make and/or to accept offers must come from decision-makers within the organization. At the same time, these decision-makers may not be the individuals tasked with negotiating the terms of the contracts over which they ultimately exercise authority. Therefore, those individuals responsible for negotiating those terms must obtain approval for each proposed contract from at least one decision-maker. Often, the authority to approve a proposed contract may be delegated across multiple decision-makers, requiring consensus to be reached and approval to be obtained from each of those decision-makers.

Furthermore, once a proposed contract has been approved or rejected, it is often necessary to notify relevant stakeholders. The individual who requested approval is only one such stakeholder. Other stakeholders may include those decision-makers who participated in the approval process. Yet other stakeholders may include individuals who did not participate in the approval process, but who must take action once a proposed contract has been approved, e.g., an engineering department. Yet other stakeholders may be individuals outside the organization, such as shareholders, creditors, etc.

In large organizations with many decision-makers and many stakeholders, several problems may arise. As the relevant decision-makers and relevant stakeholders may vary with the nature of the proposed contract, for any particular proposed contract, it may be difficult to identify all the decision-makers from whom approval should be requested. It may also be difficult to track who has granted such approval at any instance in time. Similarly, it may be difficult to identify the relevant stakeholders who should be notified, and who has been notified at any instance in time.

Traditionally, organizations have relied on best-efforts adherence to established policy to ensure that necessary approvals are obtained and relevant stakeholders are notified. However, such efforts are prone to human error. Approvals may be missed, resulting in contracts binding upon an organization being formed before the requisite review has been conducted and the proper approval has been granted. Notifications to stakeholders may also be missed, causing a breakdown in communication when a decision to approve or reject a proposed contract has been made. Such efforts may also be slow and inefficient, thereby jeopardizing time-sensitive contract negotiations.

The above-described problems may manifest with particular severity in a commercial property leasing firm due to the complexity of such an organization, and the complexity of typical contracts—in the form of leases—formed by such an organization.

Accordingly, there is a need for improved methods, software, and devices for requesting approval of a proposed contract from multiple decision-makers and notifying multiple stakeholders when the proposed contract is approved or rejected.

### SUMMARY

In accordance with an aspect of the present disclosure, there is provided a computer-implemented method of requesting approvals for a proposed contract from a plurality of decision-makers. The method comprises: receiving (e.g., at a computing processor, such as a computer) a plurality of contract parameters of the proposed contract; comparing the plurality of contract parameters of the proposed contract to stored approval criteria to construct query parameters for identifying the plurality of decision-makers from whom approval of the proposed contract is required; retrieving electronic contact information for the identified plurality of decision-makers using the query parameters from at least one data structure; generating an electronic representation of differences between the plurality of contract parameters and a prior-received plurality of contract parameters of the proposed contract; arranging the plurality of identified decision-makers in a hierarchical order; sending by electronic communication the generated electronic representation of differences to a first identified decision-maker, as ordered upon the arranging, of the identified plurality of decision-makers; receiving an electronic notification of approval by the first identified decision-maker for the proposed contract; upon the receiving, repeating the sending and the receiving for each subsequent decision-maker, as ordered upon the arranging, of the plurality of identified decision-makers; and providing electronic notification to at least one stakeholder of approval of the proposed contract upon receiving electronic notification of approval by all decision-makers of the plurality of identified decision-makers. One or more of the above steps can be executed on one or more computing processors and instructions for those steps may be stored in non-transitory memory in communication with the computing processor(s).

In accordance with another aspect of the present disclosure, there is provided a computing device for requesting approvals for a proposed contract from a plurality of decision-makers. The computing device comprises: a processor; non-transitory memory in communication with the processor; and software code stored in the memory, executable on the processor. The software code comprises: a deal entry module for receiving a plurality of contract parameters of the proposed contract from a remote device in communication with the computing device; a decision-maker identification module for comparing the plurality of contract parameters of the proposed contract to stored approval criteria to construct query parameters for identifying the plurality of decision-makers from whom approval of the proposed contract is required; and retrieving electronic contact information for the identified plurality of decision-makers using the query parameters from at least one data structure; a comparison module generating an electronic representation of differences between the plurality of contract parameters and a prior-received plurality of contract parameters of the proposed contract; a request approval module for arranging the plurality of identified decision-makers in a hierarchical order; sending by electronic communication the generated electronic representation of differences to a first identified decision-maker, as ordered upon the arranging, of the identified plurality of decision-makers; receiving an electronic notification of approval by the first identified decision-maker for the proposed contract; and upon the receiving, repeating the sending and the receiving for each subsequent decision-maker, as ordered upon the arranging, of the plurality of identified decision-makers; and a stakeholder notification module for providing electronic notification to at least one stakeholder of approval of the proposed contract upon receiving electronic notification of approval by all decision-makers of the plurality of identified decision-makers.

In accordance with yet another aspect of the present disclosure, there is provided a non-transitory computer-readable medium storing instructions which when executed adapt a computing device to: receive a plurality of contract parameters of a proposed contract; compare the plurality of contract parameters of the proposed contract to approval criteria stored at the computing device to construct query parameters for identifying the plurality of decision-makers from whom approval of the proposed contract is required; retrieve electronic contact information for the identified plurality of decision-makers using the query parameters from at least one data structure stored at the computing device; generate an electronic representation of differences between the plurality of contract parameters and a prior-received plurality of contract parameters of the proposed contract; arrange the plurality of identified decision-makers in a hierarchical order; send by electronic communication the generated electronic representation of differences to a first identified decision-maker, as ordered upon the arranging, of the identified plurality of decision-makers; receive an electronic notification of approval by the first identified decision-maker for the proposed contract; upon the receiving, repeat the sending and the receiving for each subsequent decision-maker, as ordered upon the arranging, of the plurality of identified decision-makers; and provide electronic notification to at least one stakeholder of approval of the proposed contract upon receiving electronic notification of approval by all decision-makers of the plurality of identified decision-makers.

Other aspects and features of the present disclosure will become apparent to those of ordinary skill in the art upon review of the following description of specific embodiments of the disclosure in conjunction with the accompanying figures.

### BRIEF DESCRIPTION OF THE DRAWINGS

In the figures, which illustrate by way of example only, embodiments of this disclosure:

FIG. 1 is a hierarchical organizational chart for an exemplary commercial property leasing firm;

FIG. 2 illustrates the approval stages through which a proposed contract may progress in contract negotiations involving an exemplary commercial property leasing firm;

FIG. 3 is a network diagram illustrating a computer network, a server and end-user devices interconnected to the network, exemplary of an embodiment of the present disclosure;

FIG. 4 is a high level block diagram of a computing device for use as the server of FIG. 3;

FIG. 5 illustrates the software organization of the server of FIG. 3;

FIG. 6 is a high level block diagram of the modules of the approval management application of FIG. 5 executing at the server of FIG. 1;

FIG. 7 is a flowchart illustrating exemplary blocks performed by the approval management application of FIG. 5;

FIG. 8 is a flowchart illustrating exemplary blocks performed by the request approval module of FIG. 6;

FIGS. 9A and 9B illustrate exemplary screens provided by the approval management application of FIG. 5 when a user specifies the parameters of a proposed contract;

FIG. 10 illustrates an exemplary screen provided by the approval management application of FIG. 5 when approval is requested from a decision-maker;

FIG. 11 illustrates an exemplary screen provided by the approval management application of FIG. 5 when approval status is monitored by a user awaiting approval;

FIG. 12 illustrates an exemplary Deal Summary Report, as generated by the approval management application of FIG. 5; and

FIG. 13 illustrates an exemplary Deal Summary Change Report, as generated by the approval management application of FIG. 5.

### DETAILED DESCRIPTION

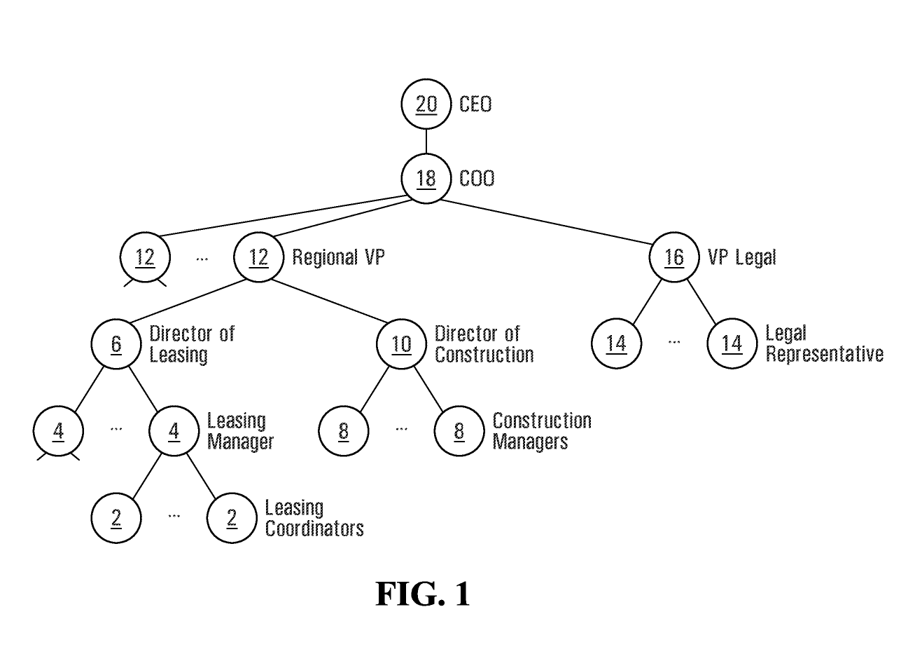

FIG. 1 is a hierarchical organizational chart for an exemplary commercial property leasing firm. As depicted in FIG. 1, the organization includes leasing coordinators 2 and leasing managers 4, who are tasked with finding prospective tenants and negotiating leases for commercial properties owned or managed by the firm. Each leasing coordinator 2 answers to a leasing manager 4, who in turn answers to a director of leasing 6. The organizational hierarchy may be traced even further upwards from a director of leasing 6 to a regional vice president 12, a chief operating officer (COO) 18 and a chief executive officer (CEO) 20.

FIG. 1 also shows different departments within the firm, each with a delegated sphere of responsibility and authority. For example, the construction department is responsible for construction work to be performed on the firm's properties. The construction department includes construction managers 8, who answer to a director of construction 10, who in turn answers to the regional vice president 12.

A legal department is responsible for managing the firm's legal issues, and comprises legal representatives 14, who answer to a vice president of legal 16, who in turn answers to the chief operating officer 18.

Depending on the nature of a particular commercial property lease, the approval process may involve any or all of the individuals shown in FIG. 1. For example, contracts with prospective and existing tenants are proposed by leasing coordinators 2 and leasing managers 4 who deal directly with those tenants. Those proposed contracts must be approved by individuals above leasing coordinator 2 in the organizational hierarchy. The extent to which approval must be obtained upwards in the organizational hierarchy may depend on the parameters of the proposed contract such as the monetary value of the lease to be created. For example, proposed contracts to create low value leases may only need to be approved by a leasing manager 4 and a director of leasing 6, while proposed contracts to create higher value leases may need to be additionally approved by regional vice president 12. Leases involving flagship properties may even need to be approved by the COO 18 or the CEO 20. Proposed contracts may also require approval from different departments within the organization. For example, proposed contracts that include unique legal clauses may need to be approved by the vice president of legal 16.

When a proposed contract has been approved or rejected, many stakeholders must be notified. Again, the relevant stakeholders may vary according to the nature of the proposed contract. For example, where a proposed contract calls for construction work to be performed on the property, once the proposed contract is approved, construction managers 8 and/or the director of construction 10 may need to be notified.

As a commercial property leasing firm typically leases unique pieces of property, the set of decision-makers from whom approval must be sought may vary significantly from lease to lease. Similarly, the set of relevant stakeholders who must be notified of an approval may also vary significantly from lease to lease. Given the complexity of the organizational structure and a large volume of proposed leases, the problems associated with requesting approval from multiple decision-makers and notifying multiple stakeholders become exacerbated.

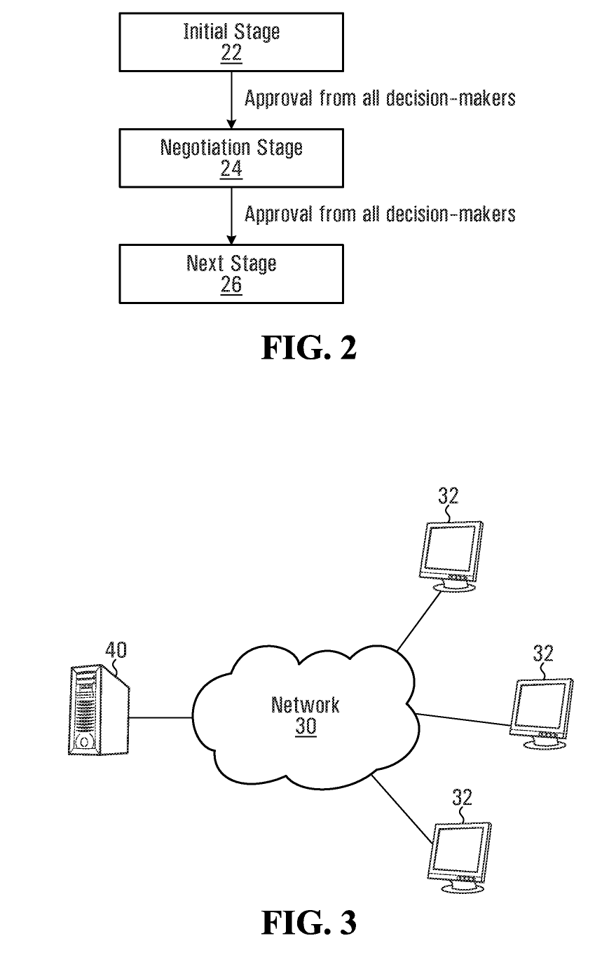

To further compound these problems, a lease may progress through multiple pre-closing approval stages, which may require approval of a proposed contract to be obtained from relevant decision-makers at each of those stages. FIG. 2 shows the progression of an approval process from Initial Stage 22 to Negotiation Stage 24 and onward. During Initial Stage 22, there may not yet be a prospective tenant identified. In this case, a leasing coordinator 2 seeks approval for a preliminary proposed contract, i.e., a preliminary set of contract terms to present to prospective tenants. Once approval is granted during Initial Stage 22, the approval process progresses to Negotiation Stage 24, at which time, a leasing manager 4 and a legal representative 14 may then begin negotiations with one or more prospective tenants. During Negotiation Stage 24, the proposed contract is refined and additional contract terms may be added or existing contract terms may be modified. The proposed contract, as modified following negotiations with a prospective tenant, must once again be approved by relevant decision-makers before a contract may be formed or before the approval process may progress to subsequent stage 26.

Furthermore, at any stage, when decision-makers have rejected a proposed contract, the proposed contract may be modified to address the concerns which motivated the rejection, and then presented once again to those decision-makers. This process of rejection and revision may iterate many times before the proposed contract is approved or the proposed contract is rejected for a final time. A decision-maker who must review several versions of a proposed contract during an approval process may miss important changes from one version to the next.

The above-described situations create the further problem of tracking multiple approvals from each decision-maker and notifying stakeholders multiple times during the course of an approval process for a single proposed contract. This creates further opportunity for error and miscommunication.

Although the above approval process and challenges have been described in the context of commercial leasing, the same problems may arise in other types of contracts in other industries. For example, an engineering firm may face similar problems with approval is sought for a proposed tender for offer.

FIG. 3 illustrates a computer network and network interconnected server 40, exemplary of an embodiment of the present disclosure. As will become apparent, server 40 is a computing device that includes software for requesting approval for a proposed contract from multiple decision-makers and notifying multiple stakeholders when the proposed contract is approved or rejected. This software adapts server 40 to allow a user, such as lease coordinator 2, to specify a proposed contract, and then requests approval from decision-makers identified to be relevant on behalf of that user; the software further adapts server 40 to notify stakeholders identified to be relevant when a proposed contract has been approved or rejected, in manners exemplary of embodiments of the present disclosure.

As illustrated, server 40 is in communication with other computing devices such as end-user computing devices 32 through computer network 30. Network 30 may be a private intranet, but could also be the public Internet. So, network 30 could, for example, be an IPv4, IPv6, X.25, IPX compliant or similar network. Network 30 may include wired and wireless points of access, including wireless access points, and bridges to other communications networks, such as GSM/GPRS/3G/LTE or similar wireless networks. When network 30 is a public network such as the public Internet, it may be secured as a virtual private network.

Example end-user computing devices 32 are illustrated. End-user computing devices 32 are conventional network-interconnected computing devices used to access data and services through a suitable HTML browser or similar interface from network interconnected servers, such as server 40. Each end-user computing device 32 is operated by individuals of the organization as shown in FIG. 1, and includes those individuals requesting approval for a proposed contract, decision-makers, and stakeholders. As such, end-user computing devices 32 may be operated to communicate with server 40 by way of network 30 to submit proposed contracts for approval, receive requests for approvals, grant/reject approvals, and/or receive notifications of approvals/rejections.

The architecture of computing devices 32 is not specifically illustrated. Computing devices 32 may include a processor, network interface, display, and memory, such as a desktop personal computer, a laptop computing device, a network computing device, a tablet computing device, a personal digital assistant, a mobile phone, or the like. As computing devices 32 access server 40 by way of network 30, they typically store and execute network-aware operating systems including protocol stacks, such as a TCP/IP stack, and web browsers such as Microsoft Internet Explorer, Mozilla Firefox, Google Chrome, Apple Safari, or the like.

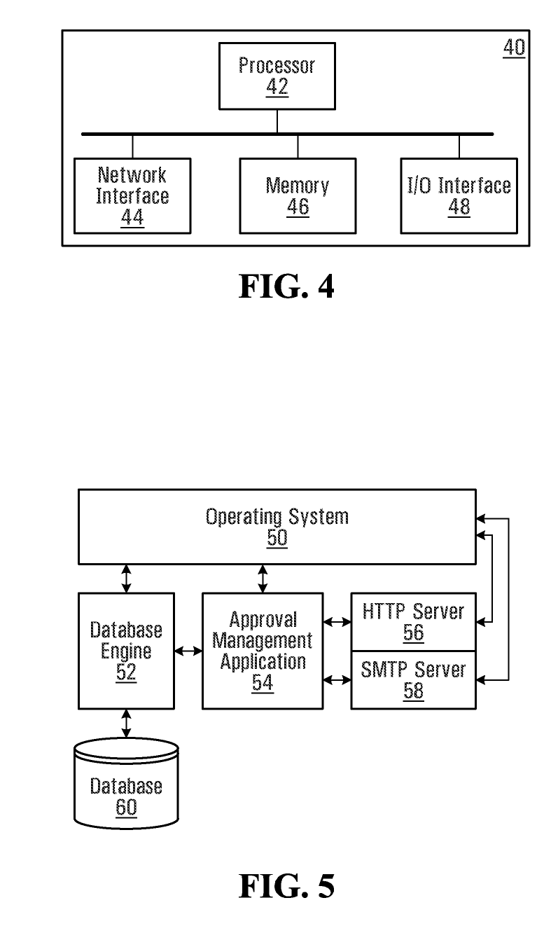

FIG. 4 is a high-level block diagram of a computing device that may act as server 40. As illustrated, server 40 includes processor 42, network interface 44, a suitable combination of persistent storage memory 46, random access memory and read-only memory, one or more I/O interfaces 48. Server 40 may for example be a conventional x86 based, Windows NT, Windows Vista, Windows XP, Windows 7, Apple, Macintosh, Linux, Solaris or similar based network server, known to those of ordinary skill. Processor 42 may be an Intel x86, PowerPC, ARM processor or the like. Network interface 44 interconnects server 40 to network 30. Memory 46 may be organized using a conventional file system, controlled and administered by an operating system governing overall operation of server 40. Server 40 may store in memory 46, through this file system, records identifying the individuals shown in FIG. 1, their respective electronic contact information, the organizational hierarchy as shown in FIG. 1, past and current versions of a proposed contract, rules for determining relevant decision-makers and stakeholders for a given proposed contract and their electronic contact information, as well as hypertext transfer protocol (“HTTP”) files to provide users an interface to interact with software exemplary of embodiments of the present disclosure, executing at server 40.

Server 40 may include input and output peripherals interconnected to server 40 by one or more I/O interfaces 48. These peripherals may include a keyboard, display and mouse. These peripherals may also include devices usable to load software components exemplary of embodiments of the present disclosure into memory 46 from a computer readable medium. Server 40 executes these software components to adapt it to operate in manners exemplary of embodiments of the present disclosure, as detailed below.

FIG. 5 illustrates a simplified organization of example software components stored within persistent memory (i.e., persistent storage memory 46) of server 40 as depicted in FIG. 4. As will be appreciated, software components embodying depicted functional blocks may be loaded from a computer readable medium and stored within persistent storage memory 46 at server 40. As illustrated, software components preferably include operating system (OS) software 50, a database engine 52, a database 60, approval management application 54, an HTTP web server application 56, and an SMTP e-mail server application 58, exemplary of embodiments of the present disclosure.

As noted, OS software 50 may, for example, be a Unix-based operating system (e.g., Linux, FreeBSD, Solaris), a Microsoft Windows operating system, or the like. OS system software 50 may also include a TCP/IP stack allowing communication of server 40 with network 30 using the TCP/IP protocol. Database engine 52 may be a conventional relational or object-oriented database engine, such as Microsoft SQL Server, Oracle, DB2, Sybase, Pervasive or any other database engine known to those of ordinary skill in the art. Database engine 52 provides access to one or more databases 60, and thus typically includes an interface for interaction with operating system software 50, and other software, such as approval management application 54. Database 60 may be a relational or object -oriented database. As will be detailed below, database 60 may store records identifying the individuals shown in FIG. 1, their respective electronic contact information, the organizational hierarchy as shown in FIG. 1, past and current versions of a proposed contract, rules for determining relevant decision-makers and stakeholders for a given proposed contract and their electronic contact information. Approval management application 54 may access these records through database engine 52. In some embodiments, approval management application 54 may access these records using an intermediary web application platform such as Microsoft SharePoint, executing at server 40.

HTTP server application 56 is a conventional HTTP web server application such as the Apache HTTP Server, nginx, Microsoft IIS or similar server application. HTTP server application 56 allows server 40 to act as a conventional HTTP server and provides a plurality of web pages, stored for example as (X)HTML or similar code, for access by network-interconnected computing devices such as end-user computing devices 32. Web pages may be implemented using traditional web languages such as HTML, XHTML, Java, Javascript, Ruby, Python, Perl, PHP, Flash or the like. Web pages may also be implemented using a web application platform such as Microsoft Sharepoint, executing at server 40.

SMTP server application 58 is a conventional SMTP e-mail server such as Microsoft Exchange, Blackberry Exchange Server, Postfix, Sendmail or similar server application. SMTP server application 56 allows server 40 to act as a conventional SMTP server for sending notification e-mails generated by approval management application 54 to be received by users operating end-user computing devices 32.

Approval management application 54 adapts server 40, in combination with database engine 52, database 60, OS software 50, HTTP server application 56 and SMTP server application 58 to function in manners exemplary of embodiments of the present disclosure. Modules of approval management application 54 may be written using conventional computing language such as C, C++, C#, Perl, Java, Visual Basic or the like. Approval management application 54 may include user interfaces written in a language allowing their presentation on a web browser, or code that will dynamically generate such user interfaces. As will be apparent, user interfaces of approval management 54 may be used by users of end-user computing devices 32 to specify parameters of a proposed contract, submit the proposed contract for approval, receive a request for approval, grant or reject approval in response to that request, or monitor approval status for a proposed contract. User interfaces of approval management application 54 may be provided in HTML, XHTML, Java or the like to HTTP server application 56 for access by network-interconnected end-user computing devices 32.

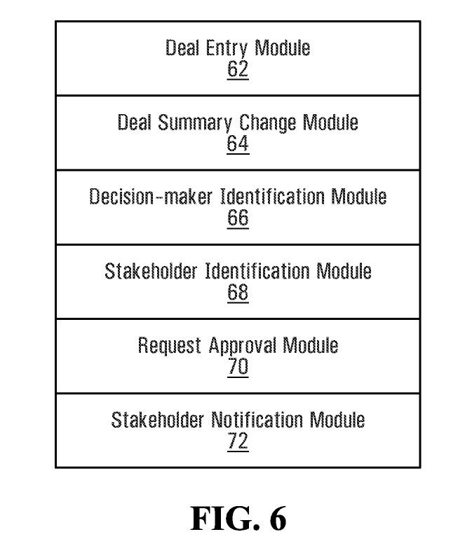

In the embodiment schematically illustrated in FIG. 6, approval management application 54 includes deal entry module 62, deal summary change module 64, decision-maker identification module 66, stakeholder identification module 68, request approval module 70, and stakeholder notification module 72.

Deal entry module 62 allows a user such as a leasing coordinator 2 to create or modify a proposed contract. A proposed contract is created by specifying its parameters, which can thereafter be modified during the approval process. To facilitate entry and modification of these contract parameters, deal entry module 62 presents a user interface in the form of a web application by way of HTTP server application 56 executing at server 40. In some embodiments, deal entry module 62 may communicate with HTTP server application 56 directly. In other embodiments, deal entry module 62 may communicate with HTTP server application 56 through an API provided by a Microsoft Sharepoint web application platform, executing at server 40.

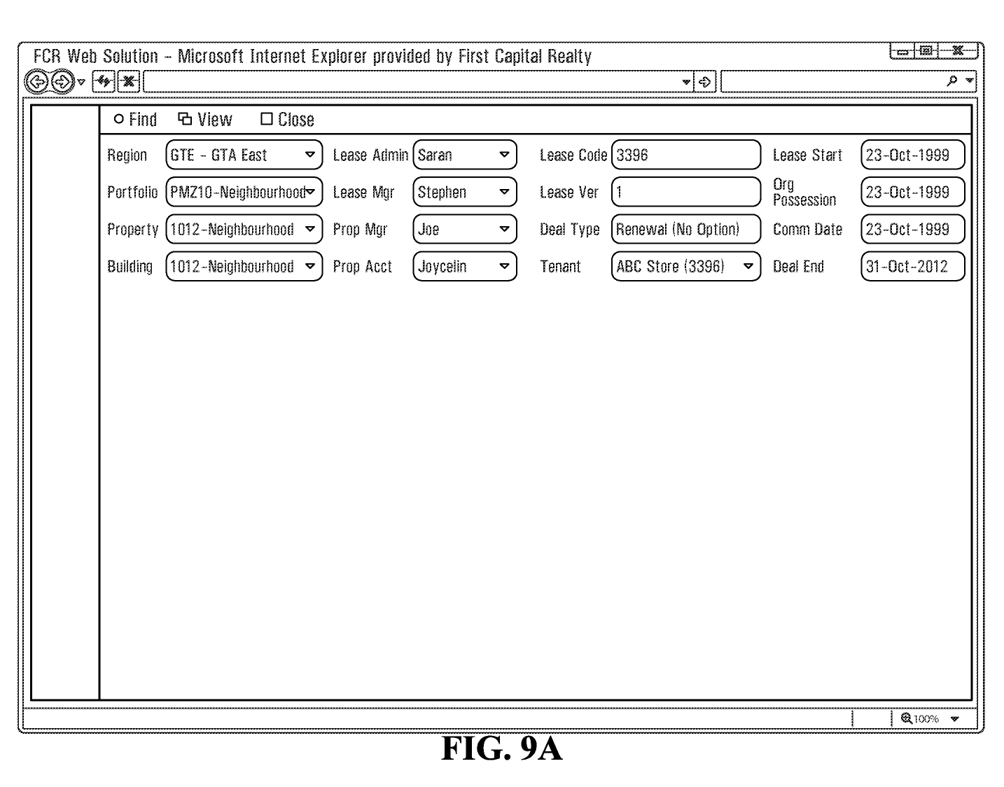

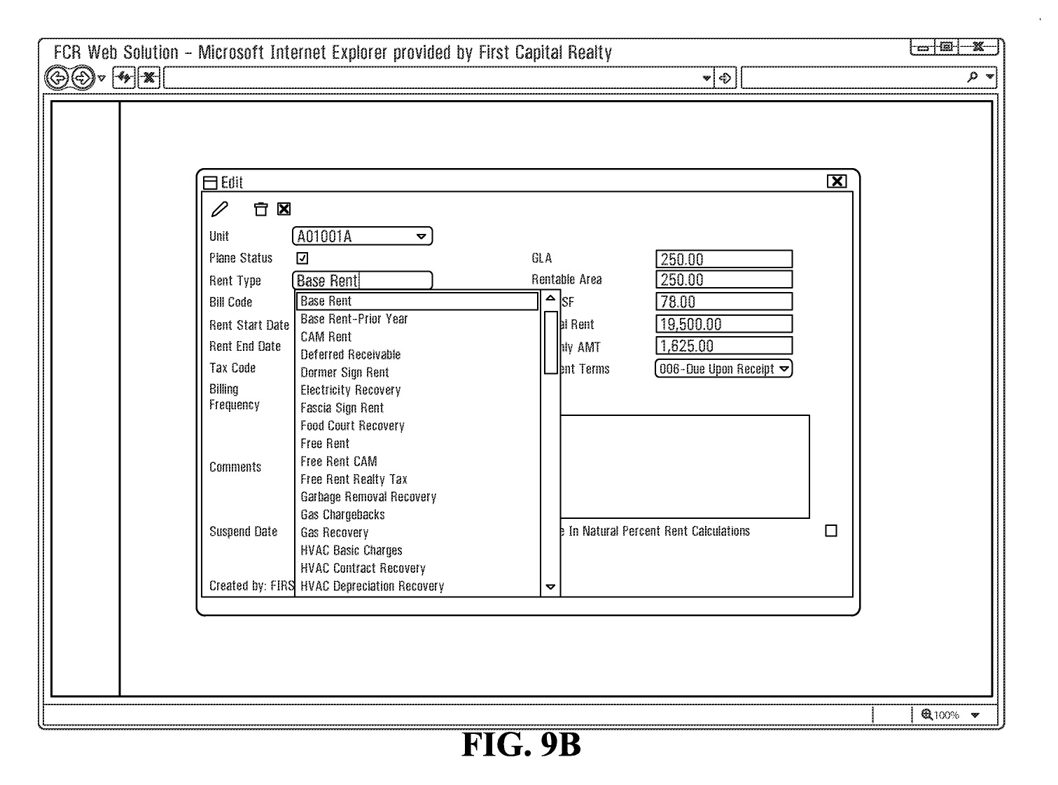

FIG. 9A depicts a sample screen of a user interface for specifying the parameters of a proposed contract, as presented to users by deal entry module 62, exemplary of an embodiment. As shown, a user is presented with a web form to enter contract parameters. These contract parameters include identifying information for a particular property, identifying information for a particular unit within a property (e.g., a particular retail space within a shopping mall), information regarding firm employees responsible for the contract to be formed and/or the particular property, lease dates, etc. FIG. 9B depicts another sample screen of a user interface for specifying rent under the lease, as presented to users by deal entry module 62, exemplary of an embodiment. This user interface may be used by users to specify rent, for example, in terms of price per square foot. Other interfaces may be provided to users for other forms of rent such as percentage rent, whereby rent may be paid according to a percentage of gross sales, for example.

In some embodiments, the user interface presented by deal entry module 62 may vary according to the stage of the approval process. For example, during Initial Stage 22, when a prospective tenant has typically not yet been identified, the user interface may not prompt users to enter tenant information by default. Afterwards, during Negotiation Stage 24, deal entry module 62 may present a user interface prompting users to modify a proposed contract by specifying parameters identifying a particular prospective tenant. Similarly, during Negotiation Stage 24, deal entry module 62 may present a user interface to allow users to enter parameters requested by particular prospective tenants such as particular conditions requested, construction work requested, legal clauses, rent rebates to the tenant, inducements to the tenant, etc.

Following entry of contract parameters specifying a proposed contract, deal entry module 62 allows the proposed contract to be submitted for approval. Deal entry module 62 may store the contract parameters in database 60 by way of database engine 52. Deal entry module 62 also generates an electronic document called a Deal Summary Report which presents the contract parameters, as entered. In some embodiments, the Deal Summary Report may show only key parameters and omit the remaining parameters. In yet other embodiments, the Deal Summary Report may show all parameters, but highlight key parameters. Deal entry module 62 may generate the Deal Summary Report in HTML format, PDF format, Microsoft Word format, or any other format suitable for presenting text.

As discussed, deal entry module 62 may also be use to modify a proposed contract, as previously specified. Modification may be necessary, for example, after progression of an approval process from Initial Stage 22 to Negotiation Stage 24. Modification may also be necessary, for example, after a proposed contract has been rejected by a decision-maker. Following rejection of a proposed contract, a user such as leasing coordinator 2 may have opportunity to modify the proposed contract by re-specifying its parameters and then re-submitting the modified proposed contract for approval.

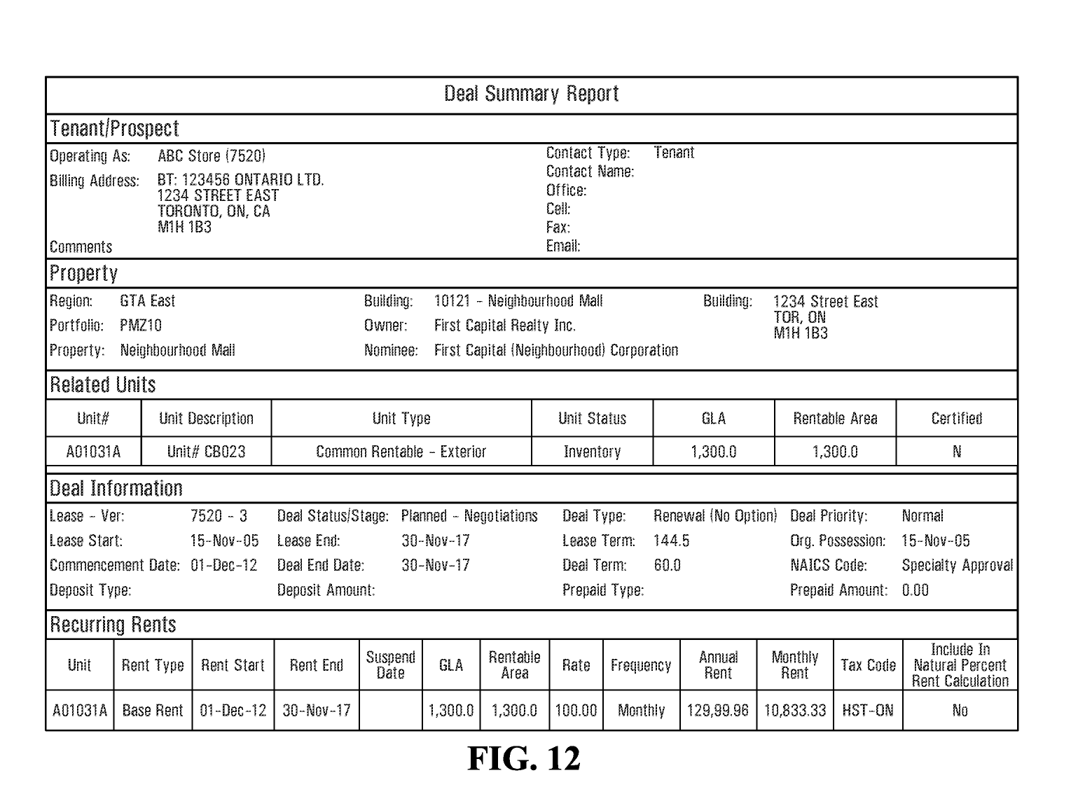

FIG. 12 depicts a sample Deal Summary Report, as generated by deal entry module 62, exemplary of an embodiment. As shown in FIG. 12, the Deal Summary Report includes contract parameters entered by a user, such as a lease coordinator 2. As detailed below, the Deal Summary Report generated by deal entry module 62 is subsequently provided to decision-makers and used by those decision-makers to evaluate a proposed contract for rejection or approval.

Deal summary change module 64 compares two versions of a proposed contract and generates a document called a Deal Summary Change Report. Deal summary change module 64 compares parameters of one version of a proposed contract with the corresponding parameters of a previous version of the proposed contract, as may be stored, for example in database 60. In some embodiments, deal summary change module 64 compares two versions of a proposed contract by comparing the Deal Summary Reports corresponding to those versions.

The comparison may be performed, for example, between the current version of the proposed contract and the version as specified prior to most recent modifications. Such a comparison would show the changes made, for example, in response to a rejection of the proposed contract by a decision-maker. As detailed below, the Deal Summary Change Report may be provided to decision-makers, and therefore may assist those decision-makers to evaluate whether or not the current version of the proposed contract has been changed to address concerns motivating a rejection of a prior version. Alternatively, the comparison may be performed, for example, between the current version of the proposed contract and the version as approved at the end of the previous stage. Such a comparison would show, for example, additions during Negotiation Stage 24 following approval of a preliminary version of the proposed contract during Initial Stage 22.

In some embodiments, deal summary change module 64 may filter contract parameters based on importance and upon filtering, omit changes to less important parameters when generating the Deal Summary Change Report. In other embodiments, deal summary change module 64 may omit parameters corresponding to a previously approved version of the proposed contract. In these embodiments, the purpose of the omissions is to reduce the amount of text presented to decision-makers which may not be relevant to the approval process, and thereby increase the efficiency of review and approval by those decision-makers.

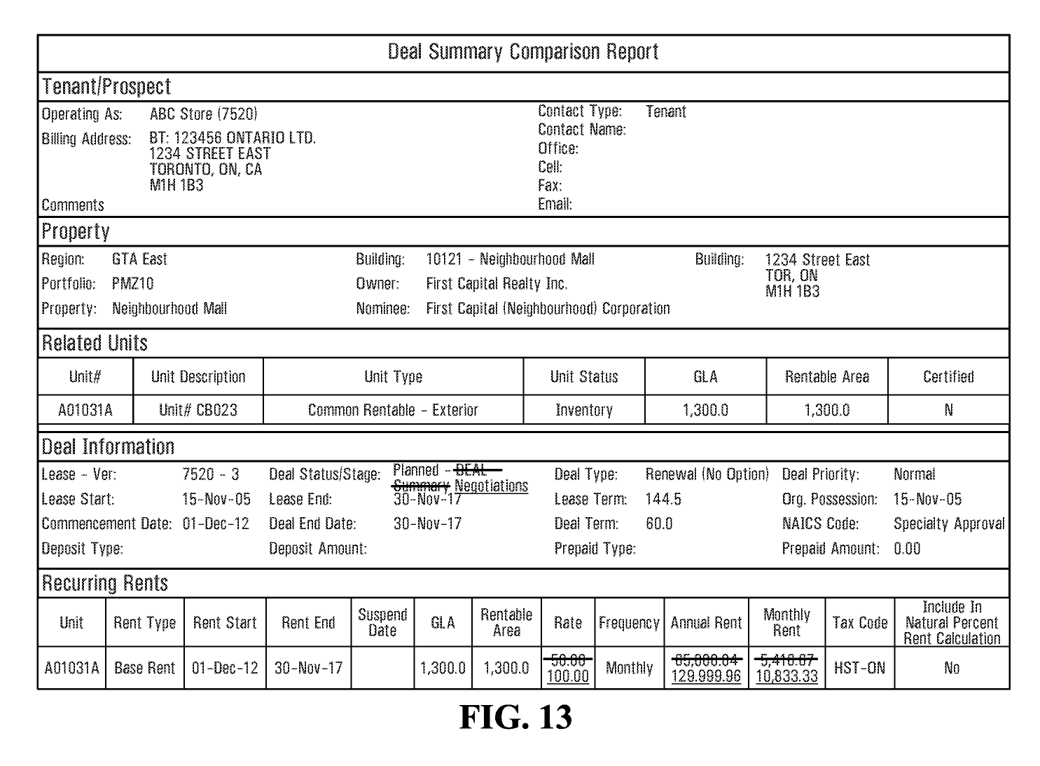

FIG. 13 depicts a sample Deal Summary Change Report, as generated by deal summary change module 64, exemplary of an embodiment. As shown in FIG. 13, the Deal Summary Change Report shows a change in a recurring rent parameter of the proposed contract. Specifically, the Deal Summary Change Report shows that the “Rate” parameter, i.e., price per square foot, has changed from $50 to $100, along with resultant changes in Monthly Rent and Annual Rent. The old parameter values are generated using strike-out font, while the new parameter values are generated using underlined font. In other embodiments, other forms of formatting may be used to identify changes, as will be readily apparent to a person skilled in the art.

In some embodiments, deal summary change module 64 may invoke or incorporate a third-party software tool to perform comparisons. A suitable third-party software tool which may be used to perform comparisons is DeltaView provided by Workshare, Inc. Deal summary change module 64 may generate the Deal Summary Report in HTML format, PDF format, Microsoft Word format, or any other format suitable for presenting text.

Decision-maker identification module 66 receives parameters of a proposed contract and compares these parameters to stored approval criteria to identify those decision-makers from whom approval must be requested. Approval criteria may be stored, for example, in database 60 and retrieved by decision-maker identification module 66 by way of database engine 52. Sample approval criteria are shown in Table I below:

TABLE I
Sample Approval Criteria

| Decision-maker | When Approval is Required |
|---|---|
| CEO | lease value >$1,000 |
| COO | lease value >$250 |
| COO | lease property area >1,000 sq. ft |
| COO | lease duration >6 months |
| Director of Leasing | lease value >$250 |
| Director of Leasing | lease property area >250 sq. ft. |
| Director of Leasing | lease duration >3 months |
| Leasing Manager | all leases |

As shown in Table I, the relevant decision-maker depends on the parameters of a proposed contract. For example, a proposed contract having a lease value of $500 would require approval from the COO 18, a director of leasing 6, and a leasing manager 4, while a proposed contract having a lease value of $2,000 would additionally require approval from the CEO 20.

Other approval criteria may be based on keyword search strings to identify the presence of specific clauses, as, for example, shown in Table II below:

TABLE II
Further Sample Approval Criteria

| Decision-maker | When Approval is Required |
|---|---|
| VP Legal | Proposed contract text contains |
| | “easements” |
| Director of Construction | Proposed contract text contains |
| | “demolition” |

As shown in Table II, a proposed contract may, for example, require review and approval by the vice president of legal 16 if it contains an easement clause. Similarly, a proposed contract may, for example, require review and approval by the director of construction 10 if it contains a demolition clause.

The approval criteria shown in Table I and Table II are exemplary only. Approval criteria may be based on any parameter of a proposed contract. Approval criteria may be tailored for a particular tenant or a particular property. Approval criteria may also depend on the current stage of the approval process. Approval criteria may vary from time to time, firm to firm, and industry to industry.

From the approval criteria, decision-maker identification module 66 obtains information identifying those decision-makers from whom approval must be requested. This identifying information may be job title, e.g., CEO, COO, and/or names of the identified decision-makers.

When a decision-maker is identified by job title and not by name, the decision-maker's name may be identified as the name of the individual holding that job title who is assigned to the particular property subject of the proposed contract. Mappings of individuals to their assigned job titles for each particular property may be stored, for example, in database 60. For example, a particular property (Mall A) may be assigned a particular leasing manager 4 (John Doe) of the leasing managers 4 depicted in FIG. 1. The mapping (Mall A, leasing manager, John Doe) may be stored, e.g., in database 60. When a proposed contract involving Mall A requires approval from a decision-maker identified as a leasing manager, the decision-maker may be identified more specifically by name as John Doe using the stored mapping.

Decision-maker identification module 66 may form a query from identifying information to search for electronic contact information for the identified decision-makers from a contact database. For example, the names and/or job titles of the identified decision-makers may be used as query parameters to search in the contacts database. This contact database may in some embodiments be database 60. Decision-maker identification module 66 provides this electronic information to request approval module 70.

Stakeholder identification module 68 is very similar to decision-maker identification module 66. Stakeholder identification module 68 receives parameters of a proposed contract which have been approved or rejected and compares those parameters to stored notification criteria to identify those stakeholders who should be notified of the approval/rejection. Notification criteria may be of the same form as the approval criteria used in decision-maker identification module 66. Notification criteria for approval of a proposed contract may differ from notification criteria for rejection of a proposed contract. Like approval criteria, notification criteria may also be stored, for example, in database 60 and retrieved by stakeholder identification module 68 by way of database engine 52. Where a stakeholder is identified by job title and not by name, the name of the stakeholder may be identified using stored mappings, as described above for decision-maker identification module 66. As noted, stakeholders include the individual who requested approval, and may also include those decision-makers who participated in granting approval. Stakeholders may further include any or all of the individuals listed in organizational chart of FIG. 1. Stakeholders may further include individuals external to the firm, such as investors, creditors, etc.

Using the notification criteria, stakeholder identification module 68 obtains information identifying those stakeholders who should be notified of the approval of a proposed contract. Like decision-maker identification module 66, stakeholder identification module 66 may form a query from this identifying information to search for electronic contact information for the identified stakeholders within a contact database. Stakeholder identification module 68 provides this electronic contact information to stakeholder notification module 72.

Request approval module 70 receives the parameters specifying a proposed contract and a list of decision-makers from whom approval must be requested, along with their electronic contact information.

Request approval module 70 requests approval from listed decision-makers in hierarchical order, starting from the bottom of the organizational hierarchy. To this end, before requesting approval from any decision-makers, request approval module 70 arranges decision-makers, as identified by decision-maker identification module 66, into a hierarchical order. This arranging may be performed by applying a set of hierarchy rules stored at server 40 to the list of identified decision-makers. These hierarchy rules may, for example, take the following form: (i) leasing manager X answers to director of leasing Y; (ii) director of leasing Y answers to regional vice president Z, and so on. In other embodiments, this arranging may be performed by analyzing a data structure (e.g., a tree data structure) describing the organizational hierarchy, as for example shown in FIG. 1.

After the identified decision-makers have been arranged into a hierarchical order, request approval module 70 sends approval request notifications to the identified decision-makers, in the order arranged. As detailed below, request approval module 70 requests approval from one decision-maker at a time, and waits to receive an electronic notification of approval the decision-maker before making a request for approval to a subsequent decision-maker. Request approval module 70 ceases to request approval for the proposed contract when it receives electronic notification of rejection by any of the decision-makers.

In sending approval requests, request approval module 70 uses the electronic contact information for the decision-maker, as provided by decision-maker identification module 66. When this electronic contact information is an e-mail address, request approval module 70 may send an e-mail to the decision-maker requesting approval for the proposed contract. This request e-mail may include a link to a web page provided at server 40 that includes a user interface that allows the decision-maker to approve or reject the proposed contract. This web page may also include information identifying the particular property to be leased. This web page may also include a link to a Deal Summary Report. When the proposed contract has undergone modification, this web page may also include a link to a Deal Summary Change Report. The web page may also include links to other documents about the particular property or the prospective tenant, e.g., a credit report, which may relevant to decision-making The requests sent by request approval module 70 may be received by a decision-maker operating an end-user device 32 interconnected with server 40.

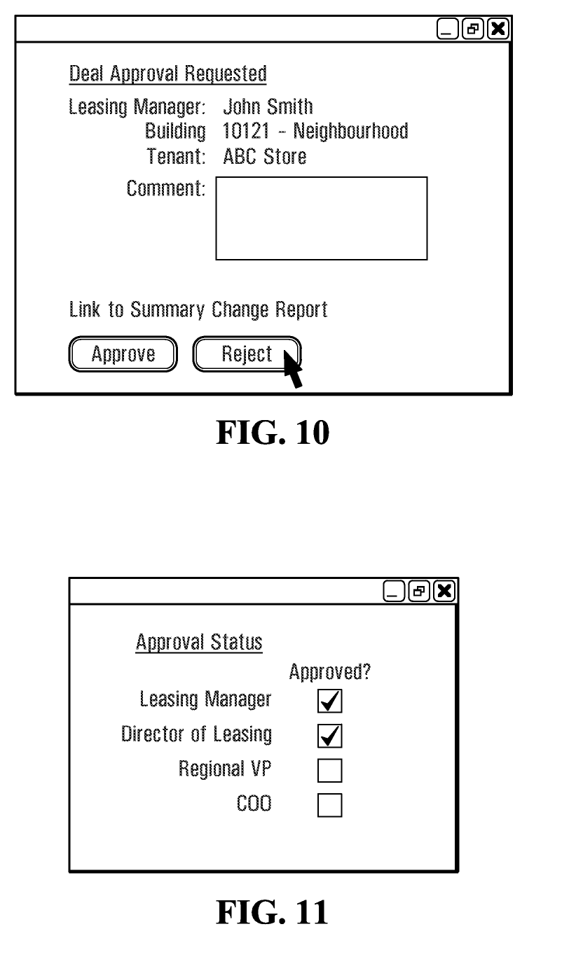

FIG. 10 shows a web page presented to a decision-maker for approving or rejecting a proposed contract, exemplary of an embodiment. As depicted, a decision-maker may approve or reject the proposed contract by simply clicking on the provided user interface buttons. A decision-maker may at the same time provide comments documenting the reason for approving or rejecting the proposed contract.

Request approval module 70 may allow users to monitor the approval status of a proposed contract. FIG. 11 shows a web page depicting a list of decision-makers from whom approval must be obtained, and indicates which of those decision-makers have thus far granted approval, exemplary of an embodiment.

In some embodiments, request approval module 70 may allow a decision-maker to reassign or delegate approval authority to another decision-maker instead of accepting or rejecting the proposed contract.

In other embodiments, request approval module 70 may simultaneously request approval from multiple decision-makers, for example, when two decision-makers are determined to be at the same level in the organizational hierarchy. In these embodiments, request approval module 70 may simultaneously request approval, for example, from director of construction 10 and director of leasing 6. In this case, request approval module 70 may wait to receive approval from both the director of construction 10 and the director of leasing 6 before requesting approval from regional vice president 12.

Stakeholder notification module 72 receives information identifying the proposed contract that has been approved or rejected, and electronic contact information for those stakeholders who should be notified from stakeholder identification module 68. When electronic contact information is provided in the form of e-mail addresses, stakeholder notification module 72 provides electronic notification of approval/rejection to stakeholders by e-mail via SMTP server 58. This electronic notification includes information identifying the proposed contract and/or the particular property to be leased, and may also include a link to a web page provided at server 40 displaying parameters of the proposed contract. The electronic notification may also provide a link to or an attachment containing a Deal Summary Report, a Deal Summary Change Report, when available, and/or other documents which may be relevant to stakeholders. This electronic notification may be received by stakeholders operating end-user devices 32 interconnected with server 40.

In some embodiments, stakeholder notification module 72 may communicate with SMTP server application 58 directly. In other embodiments, stakeholder notification module 72 may communicate with SMTP server application 58 through an API provided by a Microsoft Sharepoint web application platform executing at server 40.

In other embodiments, stakeholder notification module 72 may provide electronic notification to stakeholders by way of other communication protocols and platforms, including instant messages, social media messages, SMS messages, web page notices, etc. Accordingly, electronic contact information may comprise instant messaging user names, social media user names, SMS numbers, web page address, etc.

In yet other embodiments, stakeholder notification module 72 may provide electronic notification using a combination of e-mail and these other communication protocols and platforms.

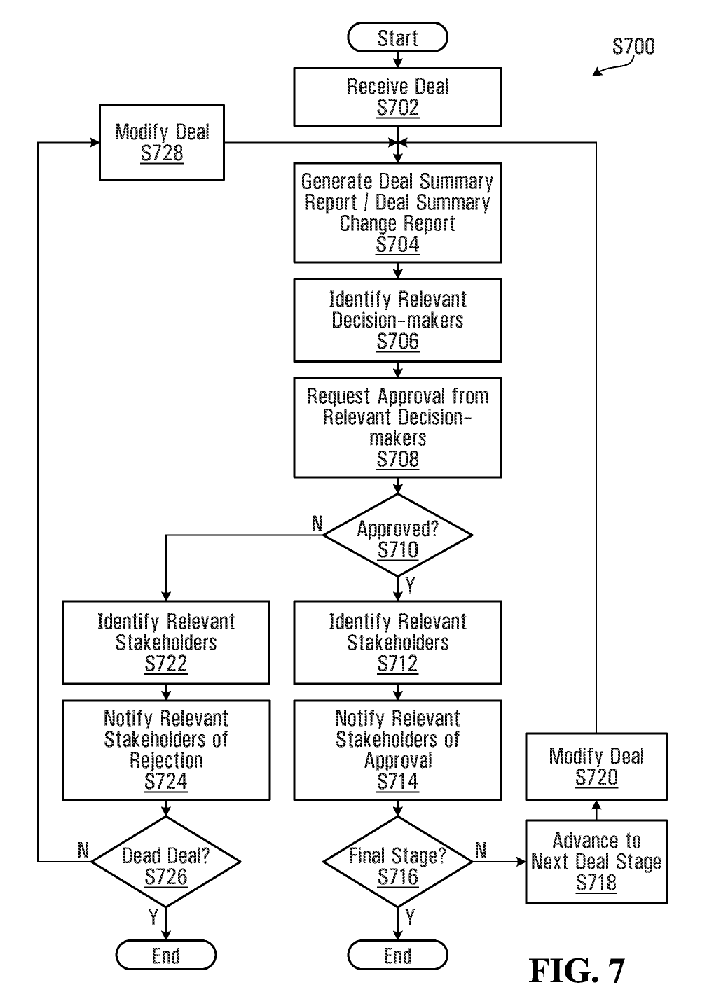

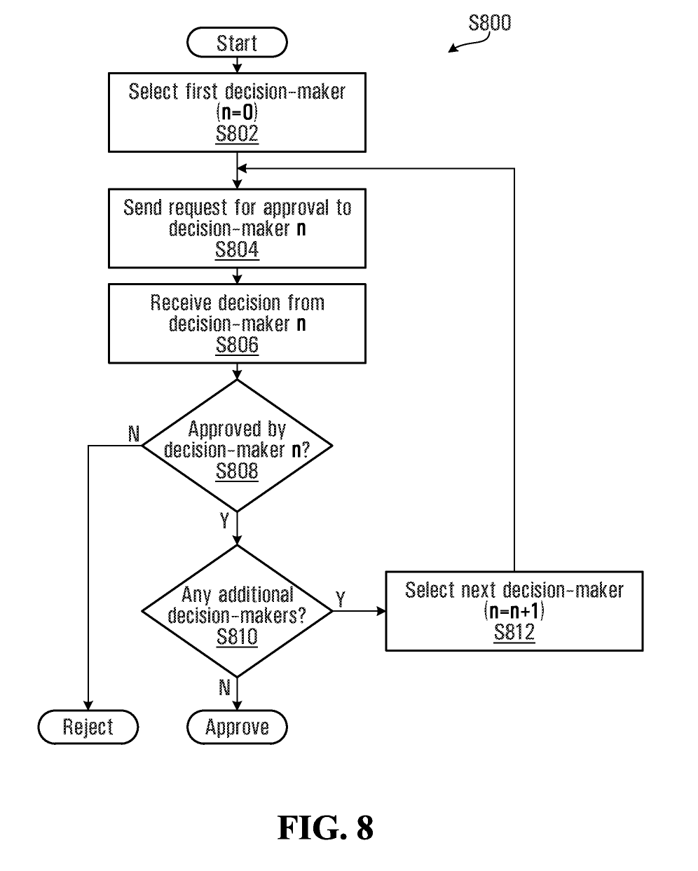

The operation of approval management application 54 is further described with reference to flowcharts depicted in FIGS. 7 and 8. To request approval for a proposed contract, approval management application 54 performs blocks S700 and onward at server 40.

At block S702, a user such a lease coordinator 2 operating an end-user device 32 proposes a new contract by specifying the parameters of the proposed contract. These parameters are entered via a user interface provided to the user by deal entry module 62. Once the proposed contract has been specified and submitted, its parameters are received by deal entry module 62. At block S704, deal entry module 62 generates a Deal Summary Report presenting some or all of these parameters. Also at block S704, if the submitted proposed contract has been modified from a previously-submitted version of the proposed contract, then deal summary change module 64 generates a Deal Summary Change Report to show the changes in the parameters from the previous version of the proposed contract.

Next, at block S706, decision-maker identification module 66 identifies those decision-makers from whom approval must be requested by comparing the parameters of the proposed contract with stored approval criteria. Decision-maker identification module 66 also searches for electronic contact information for the identified decision-makers. The identities of these decision-makers and their electronic contact information are provided to request approval module 70, which requests approval from each of these decision-makers at block S708.

The operation of request approval module 70 at block S708 is shown in more detail in the flowchart of FIG. 8. Approval from the identified decision-makers is requested by performing blocks S800 onward. At block S802, request approval module 70 first arranges the identified decision-makers in hierarchical order. Then request approval module 70 selects the first decision-maker in this hierarchical order. At block S804, an approval request is sent to this first decision-maker along with a Deal Summary Report and/or a Deal Summary Change Report, if available. The first decision-maker reviews the parameters of the proposed contract, and then either approves the proposed contract or rejects it. At block S806, request approval module 70 receives electronic notification of the first decision-maker's decision. The electronic notification is assessed at block S808. If the electronic notification indicates that the proposed contract has been rejected, request approval module 70 stops performing any of blocks S800 onward. If, however, the electronic notification indicates that the proposed contract has been approved, request approval module 70 checks to see if there are any decision-makers from whom approval has not yet been requested. If so, at block S812, the next (second) decision-maker is selected. Request approval module performs S804 once more and sends a request for approval to the second decision-maker. In this manner, request approval module 70 requests approval from each decision-maker by iteratively performing blocks S804 through S812.

Once request approval module 70 has completed performing blocks S800 and onward, block S710 is performed. At S710, if request approval module 70 received electronic notification of approval from each identified decision-maker, then the proposed contract is considered approved. Conversely, at S710, if request approval module 70 received electronic notification of rejection from any identified decision-maker, then the proposed contract is considered rejected. If the proposed contract is approved, then at block S712, stakeholder identification module 68 identifies those stakeholders who should be notified that the proposed contract has been approved. This identification is performed by comparing the parameters of the approved proposed contract with stored notification criteria for approvals. At block S714, stakeholder notification module 72 electronically notifies identified stakeholders of the approval of the proposed contract.

At block S716, a determination is made as to whether there are any subsequent stages. If there are no subsequent stages, then the approval process has been successfully completed and execution of approval management application 54 terminates. If, however, there is a subsequent stage (e.g., Initial Stage 22 has just concluded), then at S718, the approval process advances to the next stage (e.g., Negotiation Stage 24). At block S720, parameters specifying the proposed contract may be modified or new parameters may be added, e.g., pursuant to negotiations with a prospective tenant. These modifications are made using a user interface provided by deal entry module 62. After the proposed contract has been modified, blocks S704 through S716 are repeated.

Returning now to block S710, if instead of receiving electronic notification of approval for the proposed contract, request approval module 70 electronic notification of rejection, then block S722 is performed. At block S722, stakeholder identification module 68 identifies those stakeholders who should be notified that the proposed contract has been rejected. This identification is performed by comparing the parameters of the approved contract with stored notification criteria for rejections. At block S724, stakeholder notification module 72 notifies identified stakeholders of the rejection of the proposed contract.

At block S726 a determination is made as to whether the proposed contract has been finally rejected, for example, if the rejection comments indicate that the proposed contract will never be approved even if modified. If the rejection is determined to be final, then execution of approval management application 54 terminates. If however, the rejection is not final, then block S728 is performed. At block S728, parameters specifying the proposed contract may be modified or new parameters may be added to address the concerns that motivated the rejection. These modifications are made using a user interface provided by deal entry module 62. After the proposed contract has been modified, blocks S704 through S716 are repeated. These blocks are repeated until the proposed contract is ultimately approved or finally rejected.

Of course, the above described embodiments are intended to be illustrative only and in no way limiting. The described embodiments of carrying out the disclosure are susceptible to many modifications of form, arrangement of parts, details and order of operation. For example, software (or components thereof) described at server 40 may be hosted at several devices. Software implemented in the modules described above could be using more or fewer modules. The disclosure, rather, is intended to encompass all such modification within its scope, as defined by the claims.

What is claimed is:

1. A computer-implemented method of requesting approvals for a proposed contract from a plurality of decision-makers, the method comprising:
receiving a plurality of contract parameters of the proposed contract;
comparing the plurality of contract parameters of the proposed contract to stored approval criteria to construct query parameters for identifying the plurality of decision-makers from whom approval of the proposed contract is required;
retrieving electronic contact information for the identified plurality of decision-makers using the query parameters from at least one data structure;
generating an electronic representation of differences between the plurality of contract parameters and a prior-received plurality of contract parameters of the proposed contract;
arranging the plurality of identified decision-makers in a hierarchical order;
sending by electronic communication the generated electronic representation of differences to a first identified decision-maker, as ordered upon the arranging, of the identified plurality of decision-makers;
receiving an electronic notification of approval by the first identified decision-maker for the proposed contract;
upon the receiving, repeating the sending and the receiving for each subsequent decision-maker, as ordered upon the arranging, of the plurality of identified decision-makers; and
providing electronic notification to at least one stakeholder of approval of the proposed contract upon receiving electronic notification of approval by all decision-makers of the plurality of identified decision-makers.

2. The method of claim 1 further comprising:
comparing the plurality of contract parameters of the proposed contract to stored notification criteria to construct further query parameters for identifying a plurality of stakeholders who should be notified of approval of the proposed contract, and
retrieving electronic contact information for the identified plurality of stakeholders using the further query parameters from a further at least one data structure.

3. The method of claim 2, wherein the providing electronic notification to the at least one stakeholder comprises providing electronic notification to the plurality of identified stakeholders.

4. The method of claim 1, further comprising receiving electronic notification of rejection of a prior version of the proposed contract.

5. The method of claim 4, further comprising providing electronic notification to at least one stakeholder of rejection of the prior version of the proposed contract upon receiving the electronic notification of rejection of the prior version of the proposed contract.

6. The method of claim 1, further comprising sending by electronic communication the plurality of contract parameters to the first identified decision-maker.

7. The method of claim 1, wherein the generating the electronic representation comprises filtering the plurality of contract parameters to include only a subset of the contract parameters.

8. The method of claim 7, wherein the filtering is according to the importance of each of the plurality of contract parameters.

9. The method of claim 1, further comprising retrieving the prior-received plurality of contract parameters from a database.

10. The method of claim 1, further comprising storing the plurality of contract parameters in a database.

11. The method of claim 1, further comprising determining the hierarchical order upon assessing stored hierarchy criteria.

12. The method of claim 1, wherein the query parameters comprise names of the plurality of decision-makers.

13. The method of claim 1, wherein the query parameters comprise job titles of the plurality of decision-makers.

14. The method of claim 1, further comprising presenting an approval status for each of the identified plurality of decision-makers.

15. The method of claim 1, wherein the electronic contact information is an e-mail address, an instant messaging user name, a social media user name, an SMS number, or a webpage address.

16. The method of claim 1, wherein the prior-received plurality of contract parameters comprise contract parameters of a previously approved version of the proposed contract.

17. The method of claim 1, wherein the approval criteria comprise contract value thresholds.

18. The method of claim 1, wherein the approval criteria comprise contract duration thresholds.

19. The method of claim 1, wherein the approval criteria comprise keywords matches.

20. The method of claim 1, further comprising:
generating a graphical representation of the plurality of contract parameters; and
sending by electronic communication the generated electronic representation of the plurality of contract parameters to the first identified decision-maker.

21. A computing device for requesting approvals for a proposed contract from a plurality of decision-makers, the computing device comprising:
a processor;
non-transitory memory in communication with the processor; and
software code stored in the memory, executable on the processor, the software code comprising:
a deal entry module for receiving a plurality of contract parameters of the proposed contract from a remote device in communication with the computing device;
a decision-maker identification module for comparing the plurality of contract parameters of the proposed contract to stored approval criteria to construct query parameters for identifying the plurality of decision-makers from whom approval of the proposed contract is required; and retrieving electronic contact information for the identified plurality of decision-makers using the query parameters from at least one data structure;
a comparison module generating an electronic representation of differences between the plurality of contract parameters and a prior-received plurality of contract parameters of the proposed contract;
a request approval module for arranging the plurality of identified decision-makers in a hierarchical order; sending by electronic communication the generated electronic representation of differences to a first identified decision-maker, as ordered upon the arranging, of the identified plurality of decision-makers; receiving an electronic notification of approval by the first identified decision-maker for the proposed contract; and upon the receiving, repeating the sending and the receiving for each subsequent decision-maker, as ordered upon the arranging, of the plurality of identified decision-makers; and
a stakeholder notification module for providing electronic notification to at least one stakeholder of approval of the proposed contract upon receiving electronic notification of approval by all decision-makers of the plurality of identified decision-makers.

22. A non-transitory computer-readable medium storing instructions which when executed adapt a computing device to:
receive a plurality of contract parameters of a proposed contract;
compare the plurality of contract parameters of the proposed contract to approval criteria stored at the computing device to construct query parameters for identifying the plurality of decision-makers from whom approval of the proposed contract is required;
retrieve electronic contact information for the identified plurality of decision-makers using the query parameters from at least one data structure stored at the computing device;
generate an electronic representation of differences between the plurality of contract parameters and a prior-received plurality of contract parameters of the proposed contract;
arrange the plurality of identified decision-makers in a hierarchical order;
send by electronic communication the generated electronic representation of differences to a first identified decision-maker, as ordered upon the arranging, of the identified plurality of decision-makers;
receive an electronic notification of approval by the first identified decision-maker for the proposed contract;
upon the receiving, repeat the sending and the receiving for each subsequent decision-maker, as ordered upon the arranging, of the plurality of identified decision-makers; and
provide electronic notification to at least one stakeholder of approval of the proposed contract upon receiving electronic notification of approval by all decision-makers of the plurality of identified decision-makers.
